(19) United States
(12) Patent Application Publication
(10) Pub. No.: US 2024/0093728 A1
(43) Pub. Date: Mar. 21, 2024

(54) ALIGNMENT MECHANISM FOR PARALLEL RUNNING LINEAR MOTION SYSTEM

(71) Applicant: Parker-Hannifin Corporation, Cleveland, OH (US)

(72) Inventors: Frank Krakosh, III, Latrobe, PA (US); James K. Monnich, JR., Greensburg, PA (US)

(73) Assignee: Parker-Hannifin Corporation, Cleveland, OH (US)

(21) Appl. No.: 18/357,569

(22) Filed: Jul. 24, 2023

Related U.S. Application Data
(60) Provisional application No. 63/375,971, filed on Sep. 16, 2022.

(51) Int. Cl. F16C 29/06

(52) U.S. Cl. CPC F16C 29/06

(57) ABSTRACT

A linear motion system comprising a first linear track that defines a first linear path, a second linear track that defines a second linear path, and a carriage connected to the first linear track and the second linear track. The system further includes an alignment mechanism configured to allow rotation of the carriage relative to the first linear track. The alignment mechanism includes an upper surface rigidly attached to the carriage, a lower surface mounted on the first linear track, a rotation interface between the upper surface and the lower surface to permit rotation of the carriage relative to the first linear track, and a linear movement interface between the upper surface and the lower surface to permit translational movement of the upper surface relative to the lower surface to permit translational movement of the carriage relative to the first linear track.

### RELATED APPLICATION

This application claims priority to U.S. Provisional Patent Application No. 63/375,971, filed Sep. 16, 2022 and titled “ALIGNMENT MECHANISM FOR PARALLEL RUNNING LINEAR MOTION SYSTEM,” the entirety of which is incorporated herein by reference.

### TECHNICAL FIELD

The present invention relates to an alignment mechanism for a parallel running linear motion system, and more particularly to such an alignment system that permits rotation of a carriage relative to a first track as the carriage travels along parallel tracks.

### BACKGROUND

Parallel running linear motion systems, such as gantry systems used in semiconductor manufacturing, include a carriage that may include that travels along two separate, parallel tracks for at least degrees of movement. As the carriage moves along the parallel tracks, maintaining appropriate alignment between the carriage and the tracks prevents crabbing or skewing of the carriage during travel that negatively impacts precision of the system.

Convention parallel running linear motion systems typically include flexure technology that provides a small amount of compliance to return the carriage from a skewed position to an aligned position. The flexure technology can include weakened connections between the carriage and the sliding portion on the track to allow the carriage to move with respect to the sliding portion and/or portions of the carriage are made of flexible material that permits the carriage to bend. However, these conventional systems rely on the carriage maintaining the initial flexibility to return to the aligned position or the weakened connections permitting flexure while also maintaining the connection between the carriage and the sliding portion.

### SUMMARY

The present application provides a parallel running motion system that includes a carriage that travels along parallel tracks and an alignment mechanism that permits rotation of the carriage relative to at least one of the tracks. The alignment mechanism includes an upper surface that is attached to the carriage, a lower surface mounted on a track, and a rotation interface between the upper surface and the lower surface to permit rotation of the carriage relative to the track

According to an aspect of the disclosure, a linear motion system comprises: a first linear track that defines a first linear path; a second linear track that defines a second linear path; a carriage connected to the first linear track and the second linear track, wherein a first portion of the component is configured to travel along the first linear path, wherein a second portion of the component is configured to travel along the second linear path; an alignment mechanism configured to allow rotation of the carriage relative to the first linear track, wherein the alignment mechanism includes: an upper surface rigidly attached to the carriage; a lower surface mounted on the first linear track; a rotation interface between the upper surface and the lower surface to permit rotation of the carriage relative to the first linear track; and a linear movement interface between the upper surface and the lower surface to permit translational movement of the upper surface relative to the lower surface to permit translational movement of the carriage relative to the first linear track.

According to another aspect of the disclosure, an alignment mechanism for a linear motion system, the alignment mechanism comprises: a first body; a second body; a third body, wherein the second body is arranged between the first body and the second body; a rotation interface between the first body and the second body to permit rotation of the second body relative to the first body; and a linear interface between the second body and the third body to permit translational movement of the third body relative to the second body.

According to a further aspect of the disclosure, a linear motion system comprises: a first linear track that defines a first linear path; a second linear track that defines a second linear path; a carriage connected to the first linear track and the second linear track; a first alignment mechanism configured to allow rotation of the carriage relative to the first linear track, wherein the alignment mechanism includes: an upper surface rigidly attached to the carriage; a lower surface mounted on the first linear track; a rotation interface between the upper surface and the lower surface to permit rotation of the carriage relative to the first linear track; and a linear movement interface between the upper surface and the lower surface to permit translational movement of the upper surface relative to the lower surface to permit translational movement of the carriage relative to the first linear track; and a second alignment mechanism configured to allow rotation of the carriage relative to the second linear track, wherein the second alignment mechanism includes: a second upper surface rigidly attached to the carriage; a second lower surface mounted on the second linear track; and a second rotation interface between the second upper surface and the second lower surface to permit rotation of the carriage relative to the second linear track.

The above presents a simplified summary in order to provide a basic understanding of some aspects of the systems and/or methods discussed herein. It is not an extensive overview of the systems and/or methods discussed herein. Nor is it intended to identify key/critical elements or to delineate the scope of such systems and/or methods.

### BRIEF DESCRIPTION OF THE DRAWINGS

FIG. 1 illustrates an exemplary parallel running linear motion system.

FIG. 2 illustrates an exemplary alignment mechanism of the parallel running linear motion system.

FIG. 3 illustrates an exploded view of the exemplary alignment mechanism of FIG. 4.

FIG. 4 illustrates another exemplary alignment mechanism of the parallel running linear motion system.

FIG. 5 illustrates an exploded view of the exemplary alignment mechanism of FIG. 6.

FIG. 6 illustrates an exemplary skewed orientation of the linear motion system of FIG. 1.

FIG. 7 illustrates another exemplary skewed orientation of the linear motion system of FIG. 1.

### DETAILED DESCRIPTION

Aspects of the present application pertain to a parallel running linear motion system which is now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details.

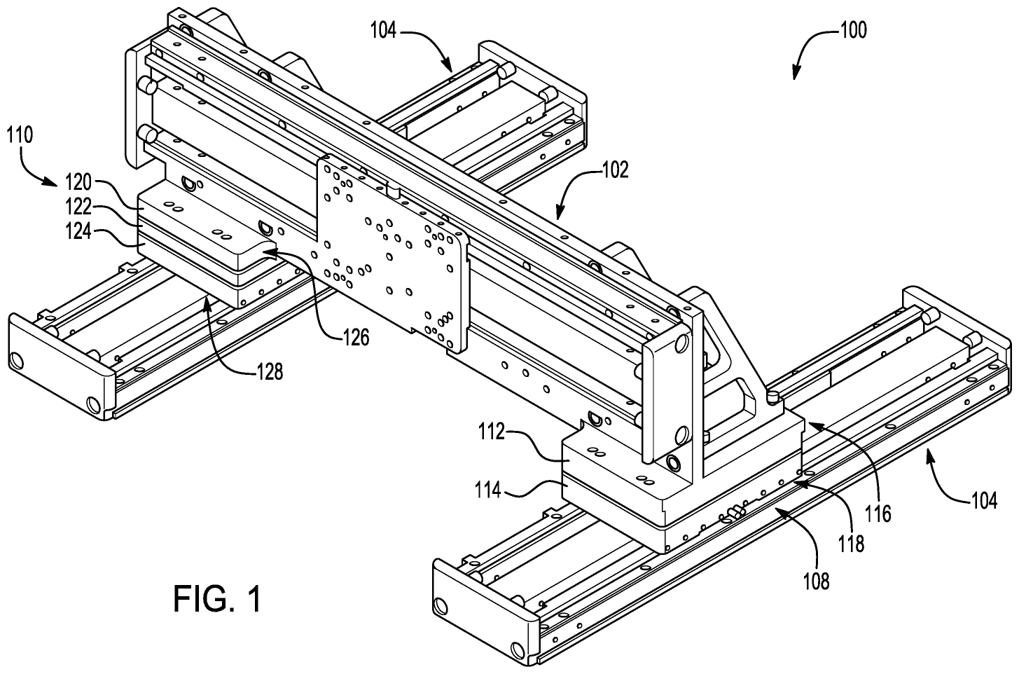

Turning to FIG. 1, illustrated is a linear motion system 100 that includes a carriage 102 that is movably connected to a first linear track 104 that defines a first linear path and to a second linear track 106 that defines a second linear path and an alignment mechanism(s) (e.g., the first alignment mechanism 108 and/or the second alignment mechanism 110) configured to permit movement of the carriage 102 relative to the first linear track 104 and/or the second linear track 106. The alignment mechanism can be used to maintain proper alignment between the carriage 102 and the first linear track 104 and/or the second linear track 106 to produce appropriate travel of the carriage 102 along the first linear track 104 and the second linear track 106. The alignment mechanism includes an upper surface (e.g., upper surface 116) that attaches to the carriage 102 and a lower surface (e.g., lower surface 118) for mounting on the linear track. In one embodiment, the lower surface is shaped to be movably attached to the linear track. In another embodiment, the lower surface is shaped for attachment to a sliding component that travels along the linear track.

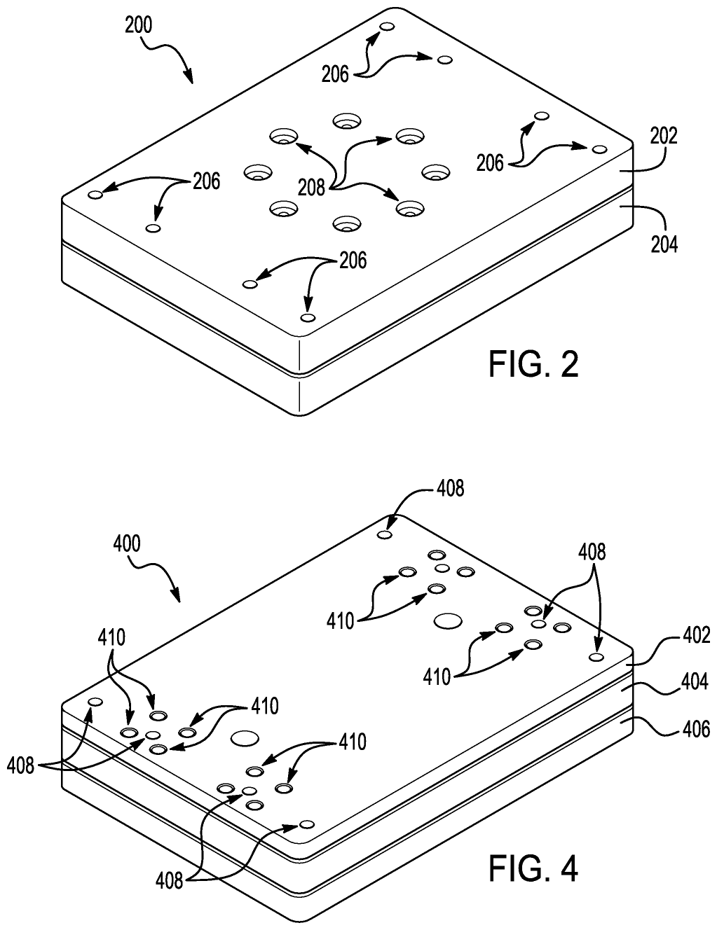

As the carriage 102 moves linearly along the first linear track 104 and the second linear track 106, maintaining appropriate alignment between the carriage 102 and the first and second linear tracks 104 and 106 prevents crabbing or skewing of the carriage 102 during travel of the carriage 102. The carriage 102 can skew when travel along one of the linear tracks is impeded while travel along the other linear track is not impeded. The alignment mechanism can be used to realign the carriage 102 with respect to the first linear track 104 and/or the second linear track 106 from a skewed position (such as that illustrated in FIG. 2) to an aligned position, as seen in FIG. 1.

Conventional linear motion systems rely on weakened connections between the carriage 102 and the sliding portion on the linear track to allow the carriage 102 to move with respect to the sliding portion and/or portions of the carriage 102 are made of flexible material that allows carriage 102 to flex in the crabbed position. However, these conventional systems rely on the carriage maintaining the initial flexibility to return to the aligned position from the skewed position and/or the weakened connections permitting rotation while also maintaining the connection.

The alignment mechanism(s) (e.g., the first alignment mechanism 108 and/or the second alignment mechanism 110) described herein overcomes one or more deficiencies of conventional linear motion system designs. For example, the alignment mechanism(s) may permit the realignment of the carriage 102 with respect to a linear track (e.g., the first linear track 104), while allowing for a rigid carriage 102 and a non-weakened connection between the carriage 102 and the linear track. The linear motion system 100 can include any suitable number of alignment mechanisms and the number may vary based on the number of tracks, the shape of the carriage 102, the size of the carriage 102, and/or the like. The alignment mechanisms can be similar and/or can vary. For instance, a first alignment mechanism can be configured to permit a first movement of a carriage relative to a first linear track (e.g., rotational movement), while a second alignment mechanism can be configured to permit a different, second movement of the same carriage relative to a second linear track (e.g., translational movement).

In FIG. 1, the linear motion system 100 includes a first alignment mechanism 108 between the carriage 102 and the first linear track 104 and a second alignment mechanism 110 between the carriage 102 and the second linear track 106. In the illustrated embodiment, the first alignment mechanism 108 is configured to allow rotation of the carriage 102 relative to the first linear track 104 and the second alignment mechanism 110 is configured to allow two different movements of the carriage 102 relative to the second linear track 106, namely rotational movement and translational movement.

The first alignment mechanism 108 includes a first plate 112 and a second plate 114. As noted above, an interface between the first plate 112 and the second plate 114 can be configured to permit rotation of the first plate 112 relative to the second plate 114, as will be described in detail below. The first plate 112 includes an upper surface 116 configured for attachment to a first portion of the carriage 102. Any suitable methods can be used to attach the first portion of the carriage 102 to the first plate 112, such as bolts, nails, screws, and/or the like, and may depend on the shape of the first plate 112 and/or the first portion of the carriage 102.

The second plate 114 includes a lower surface 118 that slidably engages the first linear track 104. In the illustrated embodiment, the lower surface 118 includes a plurality of protrusions that slidably engage corresponding recesses in the first linear track 104 that define a first linear travel path. By connecting the second plate 114 to the first linear track 104 and the first plate 112 to the carriage 102, the rotation interface allows the carriage 102 to rotate with respect to the first linear track 104 without putting additional stress on the body of the carriage 102 and/or the connection between the carriage 102 or the first linear track 104.

The first plate 112 and the second plate 114 can take any suitable shape and/or size for the features described herein. Moreover, the first plate 112 and the second plate 114 can be the same size and shape at the interface therebetween (as illustrated) and/or can vary. In the illustrated embodiment, the first plate 112 and the second plate 114 have a generally rectangular cross-section.

As mentioned above, the second alignment mechanism 110 is configured to allow both rotational and translational movement. A single plate interface can be configured for both movements and/or different plate interfaces can be used for the different movements. In the illustrated embodiment, different plate interfaces are configured for different movements. More particularly, a first plate interface is configured for rotational movement while a second plate interface is configured for translational movement.

The illustrated second alignment mechanism 110 includes a first plate 120, a third plate 124, and a second plate 122 between the first plate 120 and the third plate 124. An interface between the first plate 120 and the second plate 122 can be configured for a first movement while an interface between the second plate 122 and the third plate 124 can be configured for a different second movement. In the illustrated embodiment, the interface between the first plate 120 and the second plate 122 can be configured for translational movement and the interface between the second plate 122 and the third plate 124 can be configured for rotational movement, as will be described in detail below. Like the first alignment mechanism 108, the first plate 120 of the second alignment mechanism 110 includes an upper surface 126 for attaching a second portion of the carriage 102 thereto and the third plate 124 includes a lower surface 128 that slidably engages the second linear track 106.

Similar to the first alignment mechanism 108, the cross-section of each plate 120, 122, and 124 can be similar and/or can vary. Moreover, the plates 120, 122, and 124 of the second alignment mechanism 110 and the plates 112 and 114 of the first alignment mechanism 108 can be similar (as illustrated) and/or can vary. Additionally, the rotational interface of the first alignment mechanism 108 and the rotational interface of the second alignment mechanism 110 can be similar and/or can vary.

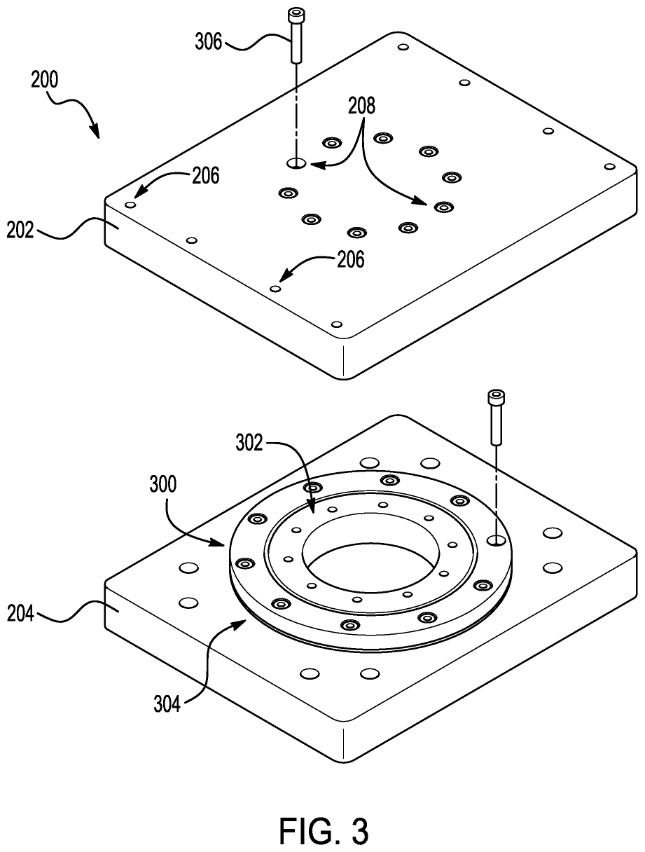

Turning to FIGS. 2 and 3, illustrated is an exemplary alignment mechanism 200 configured for rotational movement (e.g., the first alignment mechanism 108) in isolation (FIG. 2) and in an exploded view (FIG. 3). The structure described below with respect to alignment mechanism 200 can be substituted for and/or used in conjunction with the structure described above for the first alignment mechanism 108. The alignment mechanism 200 includes a first plate 202 that is rotationally connected to a second plate 204. In the illustrated embodiment, the first plate 202 and the second plate 204 are the same size and shape, but they may vary based on the desired use of the alignment mechanism 200.

The first plate 202 can include structure for securing the carriage 102 thereto and/or structure for rotationally securing the first plate 202 to the second plate 204. The alignment mechanism 200 further includes an interface between the first plate 202 and the second plate 204 that is configured for rotation of the first plate 202 relative to the second plate 204.

In the illustrated embodiment, the first plate 202 includes a first hole(s) 206 for securing the carriage 102 to the first plate 202. The first holes 206 can take any suitable shape and/or size based on the size of the carriage 102, the shape of the carriage 102, the connectors that attach the carriage 102 to the first plate 206, and the like. The illustrated first holes 206 are arranged at a first side and a second side of the first plate 202. The first holes 206 extend downward from an upper surface of the alignment mechanism 200 to receive and retain the connectors.

The first plate 202 further includes a second hole(s) 208 shaped and positioned for rotationally attaching the first plate 202 to the second plate 204. In the illustrated embodiment, the second holes 208 are arranged in a circle in the center of the first plate 202 and extend from the upper surface of the alignment mechanism 200 to align with corresponding indents and/or holes in the rotation structure of the alignment mechanism 200.

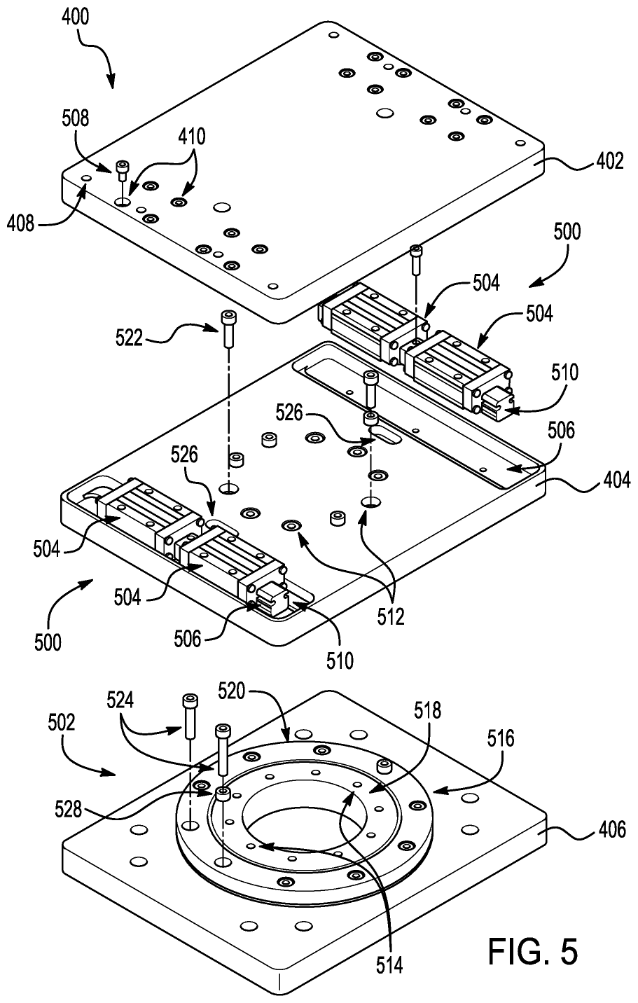

As can be seen in the exploded view in FIG. 3, the interface between the first plate 202 and the second plate 204 includes rotation structure 300 permitting rotation of the first plate 202 relative to the second plate 204. The illustrated rotation structure comprises a roller element bearing 300 (FIG. 5) with an inner ring 302 that rotates with respect to an outer ring 304. The inner ring 302 can be secured to the first plate 202 via a first connector (e.g., bolt, screw, nail, etc.) while the outer ring 304 can be secured to the second plate 204 via a second connector (e.g., bolt, screw, nail, etc.) to permit rotation of the first plate 202 with respect to the second plate 204. As can be seen more clearly in FIG. 3, the second holes 208 of the first plate 202 align with corresponding indents in the inner ring 302. In the illustrated embodiment, the alignment mechanism 108 includes a second hole 208 for each indent in the inner ring 302, but fewer second holes 208 than indents in the inner ring 302 is contemplated. The view in FIG. 3 includes a bolt 306 aligned with a second hole 206 that extends therethrough to secure the first plate 202 to the inner ring 302.

Turning to FIGS. 4 and 5, illustrated is an exemplary alignment mechanism 400 configured for rotational and translational movement (e.g., the second alignment mechanism 110) in isolation (FIG. 4) and in an exploded view (FIG. 5). The structure described below with respect to alignment mechanism 400 can be substituted for and/or used in conjunction with the structure described above for the first alignment mechanism 110. The alignment mechanism 400 includes a first plate 402, a third plate 406, and a second plate 404 between the first plate 402 and the third plate 406. In the illustrated embodiment, the second plate 404 and the third plate 406 are the same shape and size while the first plate 402 is thinner than the second plate 404 and third plate 406. However, it is conceivable that the plates may all have similar shape and size and/or all the plates may vary. The alignment mechanism 400 illustrates an exemplary embodiment where different interfaces between plates are configured for different movements, namely an interface between the first plate 402 and the second plate 404 includes structure for translational movement while an interface between the second plate 404 and the third plate 406 includes structure for rotational movement.

Similar to the first plate 202 of the alignment mechanism 200 (FIG. 2), the first plate 402 of the alignment mechanism 400 includes structure for securing the carriage 102 thereto. More particularly, the first plate 402 includes one or more holes 408 arranged along one or more edges of the first plate 402. The first plate 402 can further includes second holes 410 for translationally securing the first plate 402 and the second plate 404 to permit translational movement therebetween.

As can be seen in the exploded view in FIG. 5, the interface between the first plate 402 and the second plate 404 includes translational motion structure 500 permitting translational movement of the first plate 402 relative to the second plate 404. Further illustrated in FIG. 5, the interface between the second plate 404 and the third plate 406 includes rotation structure 502 permitting rotation of the first plate 202 relative to the second plate 204.

In the illustrated embodiment, the translational motion structure 500 comprises a linear guide bearing 500 guide blocks 504 that travel along a linear rail 506 but any suitable structure 500 can be used. The holes 410 align with corresponding indents in the guide blocks 504 to secure the first plate 402 to the guide blocks 504 (via bolts 508) such that movement of the guide blocks 504 along the rail 506 moves the first plate 402 translationally with respect to the second plate 404. The rail 506 can be attached to the second plate 404 at any suitable location, and in the illustrated embodiment, is attached in a corresponding indent 510 in the second plate 404 via a connector, such as bolt. In the illustrated embodiment, the second plate 404 includes a first indent 510 that extends linearly adjacent a first edge of the second plate 404 and a second indent 510 that extends linearly adjacent a second edge of the second plate 404 that is opposite the first edge.

The alignment mechanism 400 can include any suitable number of guide blocks 504 and/or linear rails 506. In the illustrated embodiment, the alignment mechanism 400 includes two linear rails 506 arranged at opposite ends of the second plate 404 and two guide blocks 504 for each rail 506. The number of guide blocks 504 and/or size of the rail 506 can be used to delineate a range of translational movement of the first plate 402 relative to the second plate 404, and vice-versa.

The second plate 404 further includes structure for rotationally securing the second plate 404 to the third plate 406. Any suitable structure is hereby contemplated and in the illustrated embodiment, the structure is similar to the structure described above with reference to FIGS. 4 and 5. More particularly, the second plate 404 includes one or more holes 512 that align with corresponding indents 514 in an inner ring 518 of a roller bearing 516. The holes 512 are shaped to receive connectors (e.g., bolts 522) for attaching the second plate 404 to the inner ring 518.

The roller bearing 516 further includes an outer ring 520 that can be connected to the third plate 406 to keep the third plate 406 in a particular position while the second plate 404 rotates via the inner ring 518. The illustrated outer ring 520 includes a plurality of holes shaped to receive connectors (e.g., bolts 524) that extend through the holes to secure the outer ring 520 to the third plate 406.

The above-described alignment mechanisms, alignment mechanism 200 and/or alignment mechanism 400, may further include structure, such as a stop, that limits a range of movement. For instance, the alignment mechanism 200 may include structure that limits a range of rotation of the first plate 202 with respect to the second plate 204. In another example, the alignment mechanism 400 may include structure that limits a range of rotation of the second plate 404 with respect to the third plate 406 and/or structure that limits a range of translational movement of the first plate 402 relative to the second plate 404.

In an exemplary embodiment, the alignment mechanism 400 further includes structure that limits a range of rotation of the second plate 404 relative to the third plate 406. In the illustrated embodiment, the second plate 404 includes an aperture 526 that defines a rotation path. Any suitable rotation path size can be used to limit the maximum rotation of the second plate 404, such as less than 360 degrees of rotation, less than 270 degrees of rotation, less than 180 degrees of rotation, less than 90 degrees of rotation, less than 45 degrees of rotation, and/or the like. In the illustrated embodiment, the aperture 526 limits the maximum rotation of the second plate 404 to 15 degrees of rotation. The second plate 404 can include any suitable number of such apertures 526, and in the illustrated embodiment, the second plate 404 includes two apertures 526 arranged on opposing portions of the second plate 404 adjacent the indents 510.

The third plate 406 includes protrusions that extend upward into the apertures 526 to travel along the rotational path defined by the apertures 526. In the illustrated embodiment, two bolts 524 each include a sleeve 528 that extends the top of the bolt 524 upward to extend into the apertures 526. As the second plate 404 rotates, the top of the extended bolt 524 travels along the rotation path defined by the aperture 526 to limit the rotation of the second plate 404 and/or the third plate 406.

The different parts of the linear motion system 100 described above can be formed of any suitable material and may vary based on the purpose of the part. For instance, the carriage 102 can be made of a first material while the first alignment mechanism 108 and/or second alignment mechanism 110 can be made of a different second material.

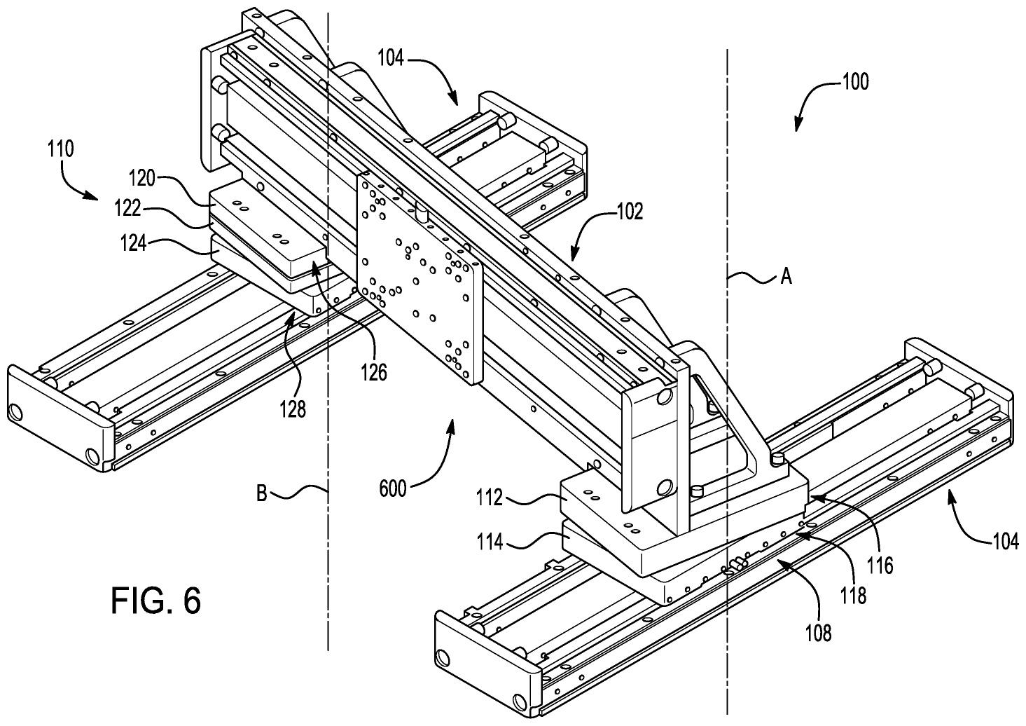

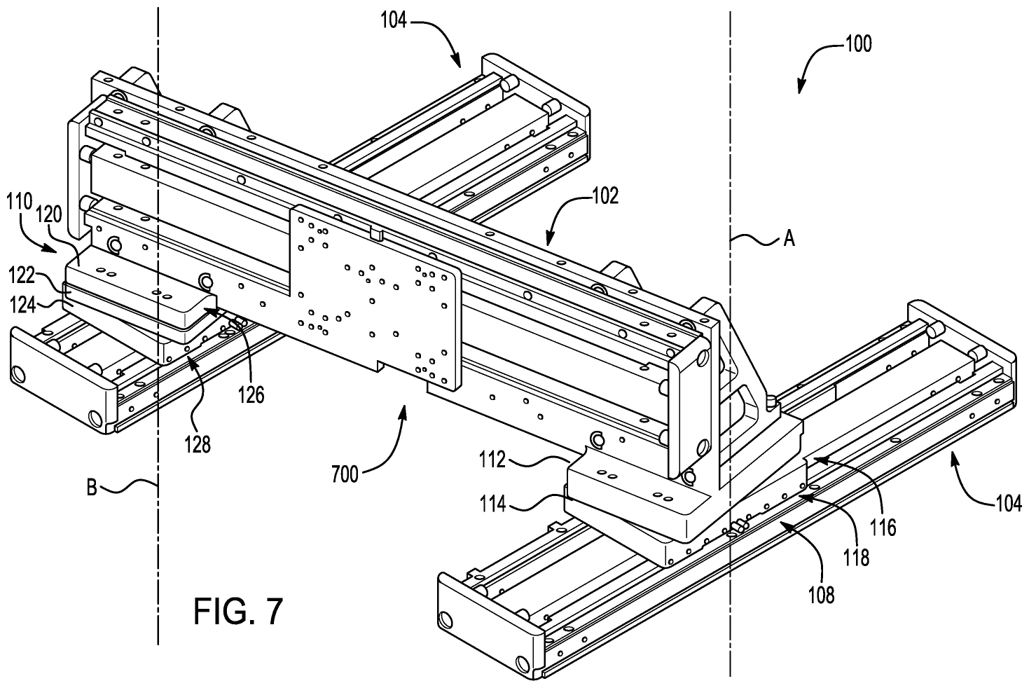

Illustrated in FIGS. 6 and 7 are embodiments of the linear motion system 100 in different skewed positions. Namely, FIG. 6 illustrates a first skewed position 600 where the carriage 102 is skewed clockwise about rotation axis A that extends through the first alignment mechanism 108. Conversely, FIG. 7 illustrates a second skewed position 700 where the carriage 102 is skewed counterclockwise about rotation axis A.

Looking specifically at FIG. 2, in the first skewed position 600, the first plate 112 rotates clockwise with respect to the second plate 114 via the rotation interface (e.g., roller element bearing 300), while the second plate 114 remains in the aligned position with respect to the first linear track 104. Accordingly, the carriage 102 can skew without placing stress on either the body of the carriage 102 and/or a connection between the carriage 102 and the sliding portion on the linear track. The rotation of the first alignment mechanism 108 causes a corresponding rotational movement of the second alignment mechanism 110. Similar to the first alignment mechanism 108, the second plate 122 of the second alignment mechanism 110 rotates clockwise with respect to the third plate 124 via the corresponding rotation interface (e.g., roller element bearing 516). Additionally, the first plate 120 moves translationally with respect to the second plate 122 via the translational movement interface (e.g., linear guide bearing 500) to accommodate the shape of the carriage 102 without placing stress on the carriage 102.

The second skewed position 700 (FIG. 3) is similar to the first skewed position 600, except that the first plate 112 of the first alignment mechanism 108 rotates counterclockwise with respect to the second plate 114 via the rotation interface (e.g., roller element bearing 300) while the second plate 114 remains in the aligned position with respect to the first linear track 104. Thus, whether the carriage 102 skews clockwise or counterclockwise with respect to the first linear track 104, the rotation interface of the first alignment mechanism 108 limits stress on the body of the carriage 102 and/or connection between the carriage 102 and the sliding portion on the linear track. This counterclockwise rotation of the first alignment mechanism 108 causes a corresponding counterclockwise rotation of the second alignment mechanism 110 via the corresponding rotation interface (e.g., roller element bearing 516). Namely, the second plate 122 rotates counterclockwise with respect to the third plate 124 while the first plate 120 moves translationally with respect to the second plate 122 to accommodate the shape of the carriage 102.

The above-described alignment mechanisms need not be limited to a linear motion system and may be used in any system where alignment between a carriage and a travel path is a consideration. For instance, the above-described alignment mechanisms can be used when the carriage travels along curving parallel paths.

According to an aspect of the disclosure, a linear motion system comprises: a first linear track that defines a first linear path; a second linear track that defines a second linear path; a carriage connected to the first linear track and the second linear track, wherein a first portion of the component is configured to travel along the first linear path, wherein a second portion of the component is configured to travel along the second linear path; an alignment mechanism configured to allow rotation of the carriage relative to the first linear track, wherein the alignment mechanism includes: an upper surface rigidly attached to the carriage; a lower surface mounted on the first linear track; a rotation interface between the upper surface and the lower surface to permit rotation of the carriage relative to the first linear track; and a linear movement interface between the upper surface and the lower surface to permit translational movement of the upper surface relative to the lower surface to permit translational movement of the carriage relative to the first linear track.

Exemplary embodiments may include one or more of the following additional features, separately or in any combination.

In exemplary embodiment(s), wherein the alignment mechanism includes: a first plate including the lower surface; a third plate including the upper surface; and a second plate arranged between the first plate and the third plate, wherein the rotation interface is arranged between the first plate and the second plate, wherein the linear interface is arranged between the second plate and the third plate.

In exemplary embodiment(s), wherein the rotation interface includes a rolling-element bearing arranged between the first plate and second plate, wherein the rolling bearing is attached to the first plate and the second plate is connected to the rolling-element bearing.

In exemplary embodiment(s), further comprising rotational range structure defining a range of rotation for the rotation of the second plate relative to the first plate.

In exemplary embodiment(s), wherein the range of rotation is 15 degrees.

In exemplary embodiment(s), wherein the rotational range structure comprises a protrusion extending from the first plate into a corresponding indent in the second plate, wherein the indent defines the range of rotation.

In exemplary embodiment(s), wherein the linear interface includes a linear-motion bearing.

In exemplary embodiment(s), wherein the linear interface includes a first linear indent and a second linear indent on a surface of the second plate facing the third plate, wherein the third plate includes a first guide block that travels linearly in the first linear indent and a second guide block that travels linearly in the second linear indent.

In exemplary embodiment(s), further comprising a second alignment mechanism configured to allow rotation of the carriage relative to the second linear track, wherein the second alignment mechanism includes: a second upper surface rigidly attached to the carriage; a second lower surface mounted on the second linear track, and a second rotation interface between the second upper surface and the second lower surface to permit rotation of the carriage relative to the second linear track

In exemplary embodiment(s), wherein the rotation interface includes a ball bearing roller-bearing element.

According to another aspect of the disclosure, an alignment mechanism for a linear motion system, the alignment mechanism comprises: a first body; a second body; a third body, wherein the second body is arranged between the first body and the second body; a rotation interface between the first body and the second body to permit rotation of the second body relative to the first body; and a linear interface between the second body and the third body to permit translational movement of the third body relative to the second body.

Exemplary embodiments may include one or more of the following additional features, separately or in any combination.

In exemplary embodiment(s), wherein the first body includes a lower mounting interface for mounting on a linear track.

In exemplary embodiment(s), wherein the third body includes an upper mounting interface for mounting a carriage thereon.

In exemplary embodiment(s), further comprising rotational range structure defining a range of rotation for the rotation of the second body relative to the first body.

In exemplary embodiment(s), wherein the linear interface includes a linear bearing mechanism on the second body and the third body is attached to the linear bearing mechanism.

In exemplary embodiment(s), wherein the linear interface includes a first linear indent that extends linearly adjacent a first edge of the second body and a second linear indent that extends linearly adjacent a second edge of the second body, wherein the second edge is opposite the first edge.

In exemplary embodiment(s), wherein the rotation interface includes a ball bearing roller-bearing element on the first body and the second body is attached to the roller-bearing element.

According to a further aspect of the disclosure, a linear motion system comprises: a first linear track that defines a first linear path; a second linear track that defines a second linear path; a carriage connected to the first linear track and the second linear track; a first alignment mechanism configured to allow rotation of the carriage relative to the first linear track, wherein the alignment mechanism includes: an upper surface rigidly attached to the carriage; a lower surface mounted on the first linear track; a rotation interface between the upper surface and the lower surface to permit rotation of the carriage relative to the first linear track; and a linear movement interface between the upper surface and the lower surface to permit translational movement of the upper surface relative to the lower surface to permit translational movement of the carriage relative to the first linear track; and a second alignment mechanism configured to allow rotation of the carriage relative to the second linear track, wherein the second alignment mechanism includes: a second upper surface rigidly attached to the carriage; ad a second lower surface mounted on the second linear track; and a second rotation interface between the second upper surface and the second lower surface to permit rotation of the carriage relative to the second linear track.

Exemplary embodiments may include one or more of the following additional features, separately or in any combination.

In exemplary embodiment(s), wherein the first alignment mechanism includes: a first plate including the upper surface; a third plate including the lower surface; and a second plate arranged between the first plate and the third plate, wherein the rotation interface is arranged between the second plate and the third plate, wherein the linear movement interface is arranged between the first plate and the second plate.

In exemplary embodiment(s), wherein the first alignment mechanism further comprises a stop defining a range of rotation for the rotation of the first plate relative to the second plate.

In reference to the disclosure herein, for purposes of convenience and clarity only, directional terms, such as, top, bottom, left, right, up, down, upper, lower, over, above, below, beneath, rear, and front, may be used. Such directional terms should not be construed to limit the scope of the features described herein in any manner. It is to be understood that embodiments presented herein are by way of example and not by way of limitation. The intent of the following detailed description, although discussing exemplary embodiments, is to be construed to cover all modifications, alternatives, and equivalents of the embodiments as may fall within the spirit and scope of the features described herein.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something and is not intended to indicate a preference.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A linear motion system comprising:
a first linear track that defines a first linear path;
a second linear track that defines a second linear path;
a carriage connected to the first linear track and the second track, wherein a first portion of the component is configured to travel along the first linear path, wherein a second portion of the component is configured to travel along the second linear path; and
an alignment mechanism configured to allow rotation of the carriage relative to the first linear track, wherein the alignment mechanism includes:
an upper surface rigidly attached to the carriage;
a lower surface mounted on the first linear track;
a rotation interface between the upper surface and the lower surface to permit rotation of the carriage relative to the first linear track; and
a linear movement interface between the upper surface and the lower surface to permit translational movement of the upper surface relative to the lower surface to permit translational movement of the carriage relative to the first linear track.

2. The linear motion system of claim 1, wherein the alignment mechanism includes:
a first plate including the lower surface;
a third plate including the upper surface; and
a second plate arranged between the first plate and the third plate, wherein the rotation interface is arranged between the first plate and the second plate, wherein the linear interface is arranged between the second plate and the third plate.

3. The linear motion system of claim 2, wherein the rotation interface includes a rolling-element bearing arranged between the first plate and second plate, wherein the rolling bearing is attached to the first plate and the second plate is connected to the rolling-element bearing.

4. The linear motion system of claim 2, further comprising rotational range structure defining a range of rotation for the rotation of the second plate relative to the first plate.

5. The linear motion system of claim 4, wherein the range of rotation is 15 degrees.

6. The linear motion system of claim 4, wherein the rotational range structure comprises a protrusion extending from the first plate into a corresponding indent in the second plate, wherein the indent defines the range of rotation.

7. The linear motion system of claim 2, wherein the linear interface includes a linear-motion bearing.

8. The linear motion system of claim 7, wherein the linear interface includes a first linear indent and a second linear indent on a surface of the second plate facing the third plate, wherein the third plate includes a first guide block that travels linearly in the first linear indent and a second guide block that travels linearly in the second linear indent.

9. The linear motion system of claim 1, further comprising a second alignment mechanism configured to allow rotation of the carriage relative to the second linear track, wherein the second alignment mechanism includes:
a second upper surface rigidly attached to the carriage;
a second lower surface mounted on the second linear track, and
a second rotation interface between the second upper surface and the second lower surface to permit rotation of the carriage relative to the second linear track.

10. The linear motion system of claim 1, wherein the rotation interface includes a ball bearing roller-bearing element.

11. An alignment mechanism for a linear motion system, the alignment mechanism comprising:
a first body;
a second body;
a third body, wherein the second body is arranged between the first body and the second body;
a rotation interface between the first body and the second body to permit rotation of the second body relative to the first body; and
a linear interface between the second body and the third body to permit translational movement of the third body relative to the second body.

12. The alignment mechanism of claim 11, wherein the first body includes a lower mounting interface for mounting on a linear track.

13. The alignment mechanism of claim 11, wherein the third body includes an upper mounting interface for mounting a carriage thereon.

14. The alignment mechanism of claim 11, further comprising rotational range structure defining a range of rotation for the rotation of the second body relative to the first body.

15. The alignment mechanism of claim 11, wherein the linear interface includes a linear bearing mechanism on the second body and the third body is attached to the linear bearing mechanism.

16. The alignment mechanism of claim 11, wherein the linear interface includes a first linear indent that extends linearly adjacent a first edge of the second body and a second linear indent that extends linearly adjacent a second edge of the second body, wherein the second edge is opposite the first edge.

17. The alignment mechanism of claim 11, wherein the rotation interface includes a ball bearing roller-bearing element on the first body and the second body is attached to the roller-bearing element.

18. A linear motion system comprising:
a first linear track that defines a first linear path;
a second linear track that defines a second linear path;
a carriage connected to the first linear track and the second linear track;
a first alignment mechanism configured to allow rotation of the carriage relative to the first linear track, wherein the alignment mechanism includes:
an upper surface rigidly attached to the carriage;
a lower surface mounted on the first linear track;
a rotation interface between the upper surface and the lower surface to permit rotation of the carriage relative to the first linear track; and
a linear movement interface between the upper surface and the lower surface to permit translational movement of the upper surface relative to the lower surface to permit translational movement of the carriage relative to the first linear track; and
a second alignment mechanism configured to allow rotation of the carriage relative to the second linear track, wherein the second alignment mechanism includes:
a second upper surface rigidly attached to the carriage;
a second lower surface mounted on the second linear track; and
a second rotation interface between the second upper surface and the second lower surface to permit rotation of the carriage relative to the second linear track.

19. The linear motion system of claim 18, wherein the first alignment mechanism includes:
a first plate including the upper surface;
a third plate including the lower surface; and
a second plate arranged between the first plate and the third plate, wherein the rotation interface is arranged between the second plate and the third plate, wherein the linear movement interface is arranged between the first plate and the second plate.

20. The linear motion system of claim 19, wherein the first alignment mechanism further comprises a stop defining a range of rotation for the rotation of the first plate relative to the second plate.
